(19) United States
(12) Patent Application Publication
(10) Pub. No.: US 2006/0279476 A1
(43) Pub. Date: Dec. 14, 2006

(54) Systems and methods for conveying message composer's state information

(75) Inventor: Hitoshi Obata, Tokyo (JP)

Correspondence Address: CROWELL & MORING LLP;INTELLECTUAL PROPERTY GROUP, P.O. BOX 14300, WASHINGTON, DC, 20044-4300, US

(73) Assignee: Gemini Mobile Technologies, Inc., San Mateo, CA (US)

(21) Appl. No.: 11/149,170

(22) Filed: Jun. 10, 2005

(51) Int. Cl. G09G 5/00

(52) U.S. Cl. 345/2.3; 340/7.52; 455/414.1

(57) ABSTRACT

Systems and methods for conveying a message composer's state to the message recipient are provided. The message composer's state can be selected by the message composer, or can be automatically determined. The message composer's state is encoded in a message and transmitted to the message recipient. The message composer's state is then output to the message recipient along with the message.

### BACKGROUND OF THE INVENTION

Inter-personal communication relies upon a number of different indicators for proper understanding of how the speaker intended a communication to be interpreted. Specifically, facial expressions, body language, and intonation must be interpreted in connection with an understanding of the speaker's customs in order to properly understand the speaker's meaning. Because a speaker's voice and intonation can be heard during remote voice communications, such as telephonic communications, the speaker's intention typically can be easily determined.

The rising popularity of text communications, such as electronic mail, short message service (SMS), and instant messaging, has resulted in many misunderstandings between the composer of a message and the recipient of the message. Specifically, there are very few ways for the composer of a message to convey the feelings and emotions (herein referred to as “state”) necessary for properly understanding the message. Accordingly, customs have been developed to remedy these deficiencies of text messaging. For example, the use of all capital letters is now commonly interpreted as yelling. Additionally, text based symbols for emotions are commonly used, such as “:-)” for indicating happiness, and “:-(” for indicating sadness. Accordingly, conventional techniques for conveying a message composer's state over communication mediums which do not easily convey the composer's state require additional work on the part of the message composer to impart the state and provide limited mechanisms for conveying the composer's state. It would be desirable to provide systems and methods for conveying a message composer's state which do not require additional work on the part of the message composer and/or provide a greater range of options for conveying a message composer's state.

### SUMMARY OF THE INVENTION

The present invention addresses the above-identified and other deficiencies of conventional communication techniques by providing systems and methods for conveying a message composer's state to a message recipient. In accordance with one embodiment of the present invention, a communication device for conveying a composer's state is provided. The communication device includes a composer state determiner which receives a message and determines a state associated with a composer of the message. The communication device also includes an encoder coupled to the composer state determiner, which encodes the state with the message, and a transmitter coupled to the encoder, which transmits the message with the encoded state.

In accordance with the present invention a communication device for receiving a composer's state is also provided. The communication device includes another receiver which receives another message, which is encoded with a state associated with a composer of the another message, and a decoder coupled to the receiver, which decodes the state associated with the composer of the another message. An output is coupled to the decoder, which outputs an indication of the state associated with the composer of the another message.

Other objects, advantages and novel features of the present invention will become apparent from the following detailed description of the invention when considered in conjunction with the accompanying drawings.

### BRIEF DESCRIPTION OF THE DRAWING FIGURES

FIG. 1a illustrates a block diagram of the functional elements of a communication device which conveys a message composer's state in accordance with one exemplary embodiment of the present invention;

FIG. 1b illustrates a block diagram of the functional elements of a communication device which conveys a message composer's state in accordance with another exemplary embodiment of the present invention;

FIG. 2 illustrates a block diagram of the functional elements of a communication device which receives and decodes a message composer's state in accordance with exemplary embodiments of the present invention;

FIG. 3a illustrates a flow diagram of an exemplary method for encoding a message composer's state in a message in accordance with the present invention;

FIG. 3b illustrates an exemplary set of displays for selecting a state in accordance with the present invention in accordance with the present invention;

FIG. 4a illustrates a flow diagram of an exemplary method for receiving and decoding a message which conveys a composer's state in accordance with the present invention;

FIG. 4b illustrates exemplary outputs of a message composer's state in accordance with the present invention; and

FIGS. 5a-5c illustrate exemplary composer state outputs in accordance with the present invention.

### DETAILED DESCRIPTION OF THE PREFERRED EMBODIMENTS

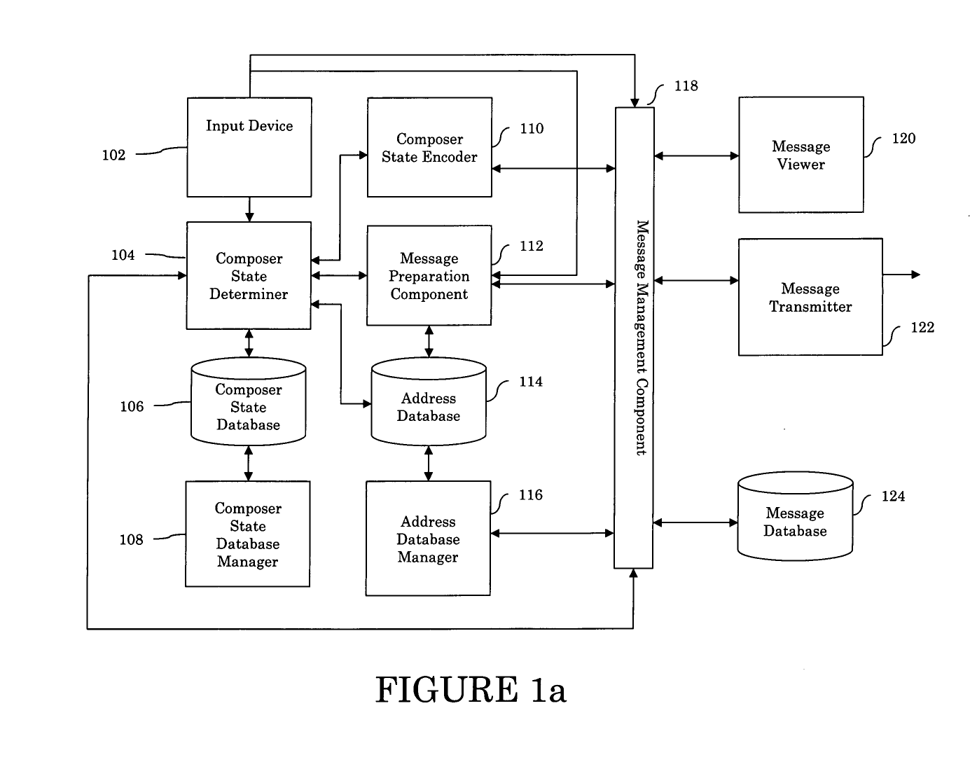

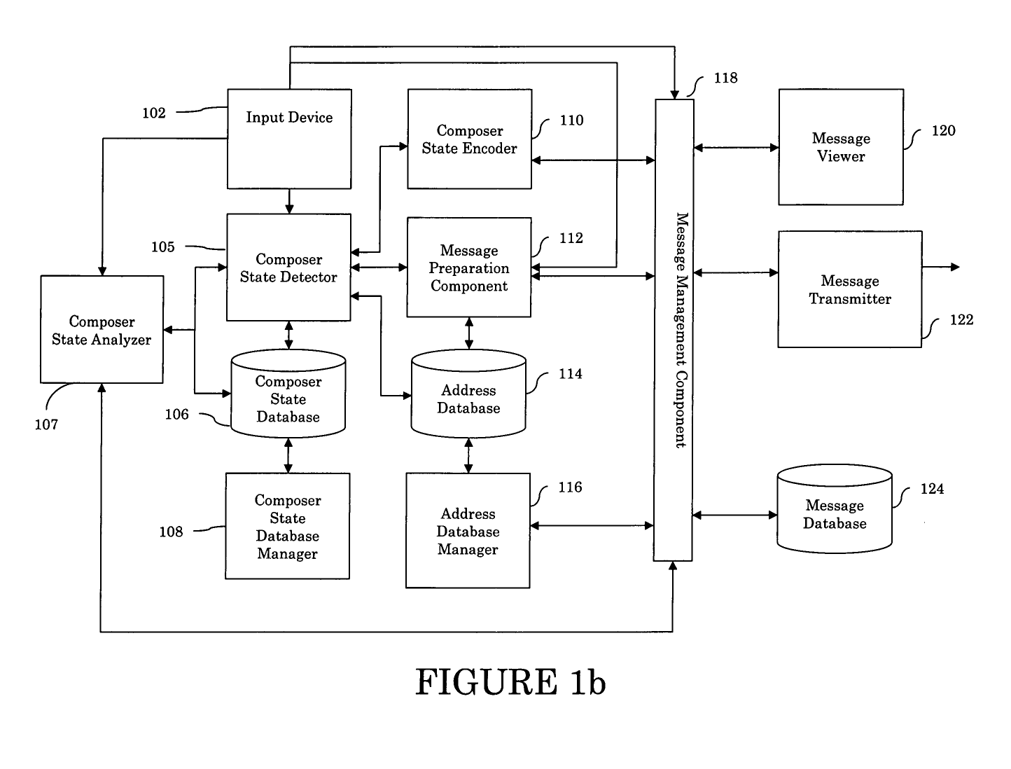

FIG. 1a illustrates a block diagram of the functional elements of a communication device which conveys a message composer's state. The communication device can be any type of communication device capable of network connectivity, including a wired or wireless telephone, pager, personal digital assistant (PDA), personal computer (PC), and/or the like. As used herein, the term message includes voice, video, audio, text and/or the like messages.

An input device 102, such as a keypad, keyboard, mouse, jog-dial switch, joystick, bar code reader, microphone, and/or the like, is used for generating a message, which is provided to message preparation component 112 or message database 124 (via message management component 118). The input device 102 is coupled to the composer state determiner 104. The composer state determiner 104 analyzes the message received from message preparation component 112 or message database 124 (via message management component 118), along with any information provided by input device 102, in order to determine a state associated with the composer of the message.

The determination of the composer's state can be performed by analyzing the text of the message (which can be based on a statistical analysis of the number of occurrences of key words), analyzing the composer's voice (for a voice message), analyzing sensors (e.g., blood pressure, heart rate, body temperature and/or the like), analysis of the composer's face (e.g., by capturing the computer's face using an image capture device and comparing the captured image to stored facial expressions), analysis of movement (e.g., by an acceleration senor) and/or the like. Alternatively, the message composer can indicate a particular state that should be associated with the message by selecting the state using input device 102, or can override the automatically determined message composer state. The message composer state can be selected by input device 102 by entering the message composer state name or message composer state identication code. Additionally, predictive text input can be employed. For example, based open the letters or numbers input by the message composer, the message composer state names or message composer state identification codes, which include the letters or numbers input by the composer, will be displayed as available selections. The message composer can select the state prior to composing the message, while composing the message, or anytime before the message is sent (e.g., while the message is in an outbox).

If desired, the message composer can provide a priority and/or privacy indicator to be associated with the state anytime before the message is sent. The priority indicator can be selected, for example, from those illustrated in the following table:

| Priority Code | Priority Type |
|---|---|
| 0 | Extreme Emergency |
| 1 | Emergency |
| 2 | Urgent |
| 3 | Hurry |
| 4 | Normal (default) |
| 5 | Low |
| 6 | Free |
| 7 | Unknown |

The privacy indicator can be set to “no privacy”, where the composer's name or other identification information can be displayed when the state is output to the message receiver, or “privacy”, where the composer's name or other identification information is not permitted to be displayed when the state is output to the message receiver. When the privacy indicator is set to “no privacy”, the message composer's name or other identification information can be displayed based on an entry for the message composer in the message recipient's address database. When there is not an entry for the message composer in the message recipient's database, other identifying information can be displayed (e.g., an e-mail address for an e-mail message, a telephone number for a voice message, etc.).

Based on the determined state, the composer state determiner 104 accesses composer state database 106 to identify a message composer state identification code. The composer state database 106 stores a plurality of different composer states in individual records. Each record can include a composer state identification code, state category, state name and state decoding actions. The following table illustrates an exemplary portion of the composer state database 106:

| | | | State Decoding Action | | | | |
|---|---|---|---|---|---|---|---|
| Composer State | State | State | | | Lamp | | |
| ID Code | Category | Name | LCD | Sub-LCD | (LED) | Vibrator | Speaker |
| 0001 | happy | delightful | DP0045 | SDP0045 | LP0022 | VP0011 | SP0023 |
| 0002 | happy | rejoice | DP0027 | SDP0027 | LP0023 | VP0033 | SP0022 |
| 0003 | happy | pleasure | DP0044 | SDP0044 | LP0034 | VP0029 | SP0045 |
| 0004 | happy | fun | DP0046 | SDP0076 | LP0019 | VP0033 | SP0054 |
| 0005 | happy | interesting | DP0028 | SDP0025 | LP0033 | VP0011 | SP0030 |
| 0006 | happy | lucky | DP0030 | SDP0031 | LP0031 | VP0046 | SP0053 |
| 0007 | happy | blessed | DP0048 | SDP0049 | LP0028 | VP0077 | SP0024 |
| 0008 | happy | glad | DP0050 | SDP0026 | LP0067 | VP0019 | SP0039 |
| . | . | . | . | . | . | . | . |
| . | . | . | . | . | . | . | . |
| . | . | . | . | . | . | . | . |
| 0021 | unhappy | boring | DP0101 | SDP0133 | LP0133 | VP0137 | SP0133 |
| 0022 | unhappy | confused | DP0122 | SDP0143 | LP0123 | VP0144 | SP0149 |
| 0023 | unhappy | depression | DP0115 | SDP0115 | LP0134 | VP0144 | SP0147 |
| 0024 | unhappy | worry | DP0130 | SDP0129 | LP0133 | VP0117 | SP0113 |
| . | . | . | . | . | . | . | . |
| . | . | . | . | . | . | . | . |
| . | . | . | . | . | . | . | . |

The composer state identification code is used by a receiving communication device to uniquely identify the particular state determined by the composer state determiner 104. The state category indicates a general emotion intended to be conveyed by the message composer, such as happy, unhappy, or the like. The state name identifies a more particular emotion from within the state category. It should be recognized that the state categories and state names in the table above are merely exemplary and other state categories and state names can be included in the composer state database 106.

The state decoding action fields include codes for a number of different devices for outputting the composer's state. These codes identify a particular action for each output device. For example, for state 0001, the liquid crystal display (LCD) would output display pattern 0045 (DP0045), the sub-LCD would output sub-display pattern 0045 (SDP0045), the light emitting diode (LED) would output light pattern 0022 (LP0022), which corresponds to a particular blinking and color pattern of the LED, the vibrator would output vibrate pattern 0011 (VP0011), and the speaker would output sound pattern 0023 (SP0023), which can be a specific sound file. It should be recognized that the output devices illustrated in the table above are merely exemplary and additional output devices with state decoding actions can be provided. Additionally, less than all of the output devices may have a state decoding action for a particular message composer state.

The composer state database 106 can be arranged in a different manner than that illustrated in the table above. For example, the state identification can be arranged by different state groups to differentiate between different types of message recipients, such as business associates, friends, family, or the like. Accordingly, some states may be appropriate for friends, but not business associates or family.

The composer state database manager 108 can be used to create (e.g., user-defined message composer states), modify, copy or delete records in the composer state database 106. The composer state database manager 108 can provide a graphical user interface, web-based interface, text-based interface, or the like.

Because the message composer state selected by the composer state determiner 104 can depend upon who the message recipient is, or the type of receiving device the message recipient uses, the composer state determiner 104 accesses the address database 114 in order to identify such. Accordingly, the address database 114 can include the recipient's address (such as telephone number, e-mail address, or the like), and the particular groups the recipient belongs to. The address database can optionally include information about whether the recipient's receiving device is capable of decoding message composer states and/or the output devices of the recipient's receiving device, which may be useful to a message composer in selecting a particular message composer state. The information in the address database can be created, modified, copied or deleted using address database manager 116. The address database manager 116 can provide a graphical user interface, web-based interface, text-based interface, or the like.

Once the composer state determiner 104 determines the state associated with the message composer, the ID of the message (Message ID), composer state identification code, priority indicator and privacy indicator are provided to the composer state encoder 110. The composer state encoder 110 digitally encodes the composer's state with the message. Specifically, the message composer state identification code corresponding to the composer's state, priority indicator, and privacy indicator are encoded with the message, which is referenced by the Message ID, which uniquely identifies the message within the communication device.

The composer's state can be encoded in a number of different ways. For example, the composer's state can be encoded in the header of an electronic mail message in ASCII format as “X-State-Coding: 002430”. The composer's state can also be encoded in the body of an electronic mail message, e.g., as the first or last line of the message, with the state identification being ASCII coded. If the message is an SMS message, the composer's state can be in a binary-coded decimal format in the header of the SMS message. When the message is a voice message, such as a telephone call, the composer's state can be encoded into the “user-to-user Information” information element of an Integrated Services User Part (ISUP) call control message.

The composer state encoder 110 provides the encoded message, via the message management component 118, to other functional elements of the communication device. For example, the composer state encoder 110 can provide the message to the message transmitter 122, which transmits the message to the message recipient identified in the message, to the message database 124, which stores the message, etc. The encoded message can be transmitted to the message recipient over any type of communication medium, including wired voice or data networks, and/or wireless voice or data networks.

The message preparation component 112 is a conventional component, which is used for composing the message. The message viewer 120 is a conventional component for viewing, or otherwise reproducing, a message. The message database 124 is a conventional component for storing messages. A composer state decoder (not illustrated) can be provided for the message composer to preview or review the message composer state encoded with the message using output devices (not illustrated).

FIG. 1b illustrates a block diagram of the functional elements of a communication device which conveys a message composer's state in accordance with another exemplary embodiment of the present invention. In FIG. 1b the composer state determiner 104 is replaced by a composer state detector 105 and a composer state analyzer 107. The composer state analyzer 107 analyzes a message received from message preparation component 112 or message database 124 to determine a message composer state and identify priority and privacy indicators. The composer state analyzer 107 then accesses composer state database 106 to identify a message composer state identification code corresponding to the determined message composer state, and provides the message composer state identification code to composer state detector 105. In addition to receiving codes from composer state analyzer 107, when the composer state detector 105 receives a composer state from input device 102, the composer state detector 105 accesses composer state database 106 to retrieve the corresponding composer state identification code. The composer state detector 105 provides the message composer state identification code to composer state encoder 110 for encoding with the message.

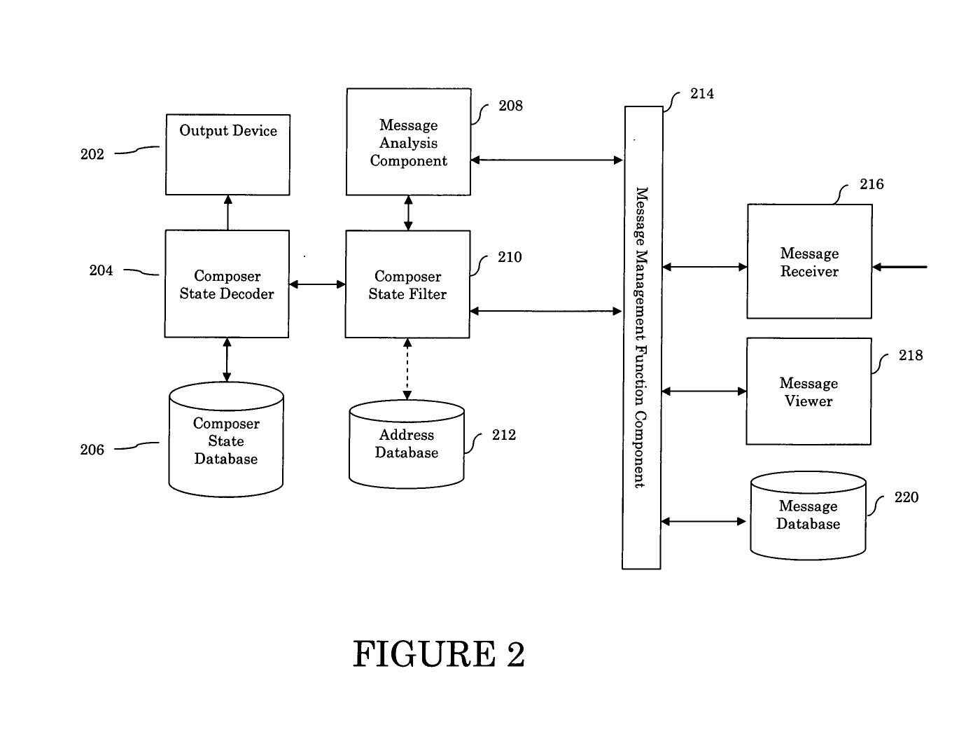

FIG. 2 illustrates a block diagram of the functional elements of a communication device which receives and decodes a message composer's state in accordance with exemplary embodiments of the present invention. Messages are received by message receiver 216, and are provided, via message management component 214, to message analysis component 208 and message database 220. Message analysis component 208 determines whether the received message includes an encoded message composer state. Message database 220 stores the message for subsequent retrieval by the message recipient using message viewer 218.

When the message analysis component 208 determines that the received message is encoded with the message composer's state, the message is provided to the composer state filter 210. The composer state filter 210 accesses address database 212 to determine whether to decode the encoded composer's state or ignore the encoded composer's state. Specifically, an information element associated with the message composer's address information can indicate whether to decode or ignore an encoded message composer state. A message recipient may set a value for the information element using an address database manager (not illustrated). Accordingly, the determination by the composer state filter 210 is based on this information element.

When it is determined that the encoded composer's state should be decoded, the composer state filter 210 provides the encoded message to composer state decoder 204. The composer state decoder 204 examines the message for the encoded message composer state, and accesses composer state database 206 to determine how to reproduce the message composer state. Apart from user-defined states, composer state database 206 should include information defining the same relationship between message composer state identification codes, state categories, and state names for each message composer state as composer state database 106, in order to properly convey the composer's state. The definition of user-defined message composer states in the composer state database should be arranged among the message composer's and recipient's communication devices to maintain the same definition between a message composer state identification code, state category and state name for particular user-defined message composer states, for proper use of these states.

The message composer state identification code is used to identify the state decoding actions for the output devices based on the state decoding action fields in the composer state database 206. If the message recipient's receiving device is not capable of decoding the message composer's state, the receiving device can ignore the state (e.g., if the state is included in a mail header that starts with “X-” for electronic mail) or can provide the state identification to the receiver (e.g., if it is included in the message body). Once the message composer state is decoded and the state decoding actions are identified, it is reproduced to the recipient on output device 202. Output device 202 can be any type of device capable of producing sensory cues, such as a speaker, lamp (e.g., LED or electric light bulb), vibrator, LCD, sub-LCD, backlight of an LCD, backlight of a sub-LCD and/or the like. Additionally, or alternatively, the output device 202 can be a sounder device, which is used to reproduce sounds (e.g., ring tones, alarms and the like) other than human voice (which is output by the speaker).

The elements of the transmitter and receiver of FIGS. 1a, 1b and 2 can be implemented by a processor and memory. For example, the databases can be implemented in one or more memories and the other functional blocks can be implemented by a processor. The processor can be a microprocessor operating according to program code, an application specific integrated circuit (ASIC), field programmable gate array (FPGA), or the like. The memory can be flash memory, random access memory, a hard drive, or the like.

For ease of explanation, and not limitation, the elements of the composing devices of FIGS. 1a and 1b and receiving device of FIG. 2 have been described separately. However, these components can be implemented in a single device, and duplicate elements described in connection with FIGS. 1a, 1b and 2 can be performed by a single element. For example, the composer state databases 106 and 206 can be the same database, address databases 114 and 212 can be the same database, and the message databases 124 and 220 can be the same database.

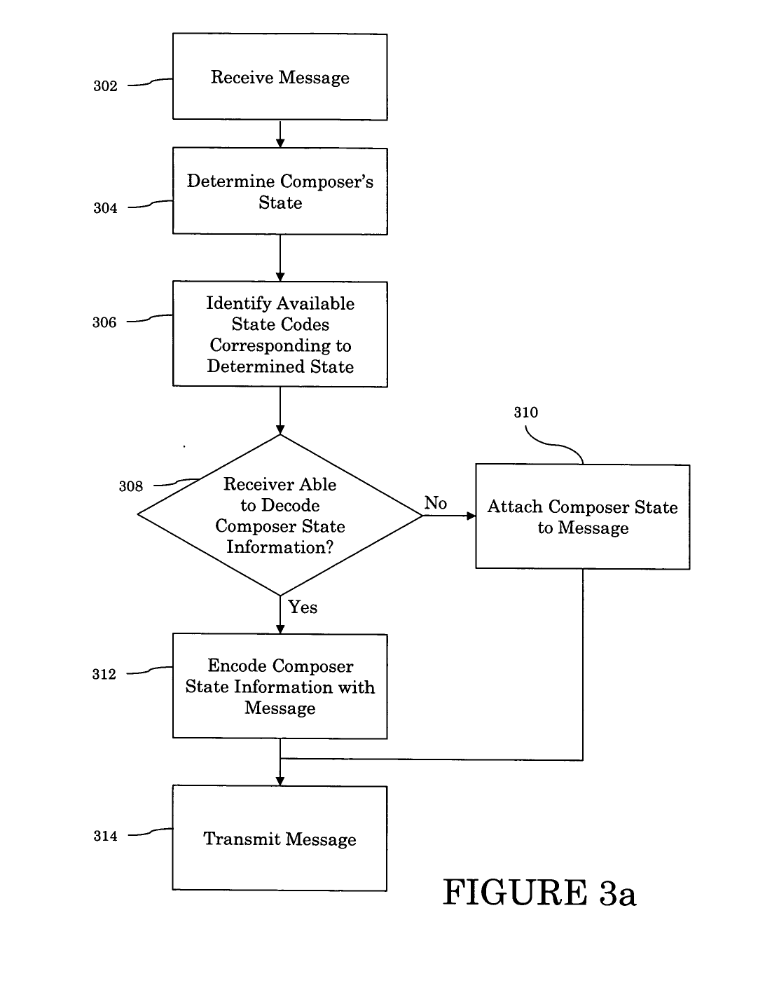

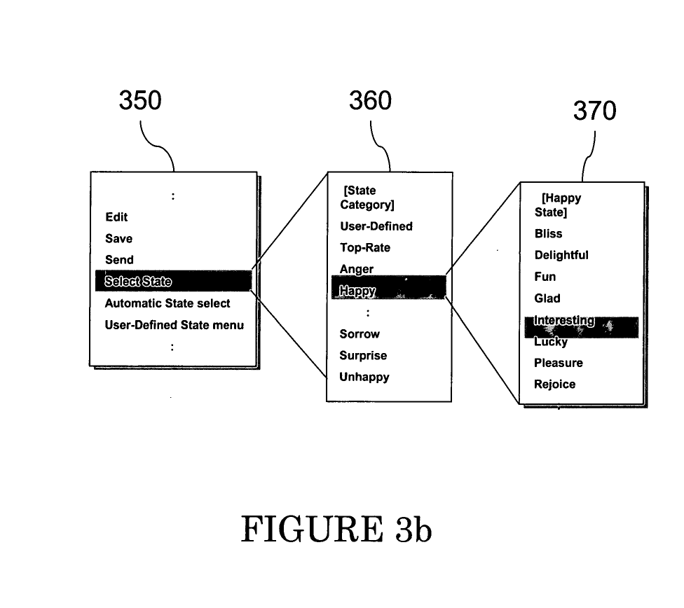

FIG. 3a illustrates a flow diagram of an exemplary method for encoding a message composer's state in a message in accordance with the present invention. When a message is received from message preparation component 112 or message database 124 (step 302), the composer state determiner 104 determines the message composer's state (step 304). As discussed above, the message composer state can be determined automatically or can be input by the message composer. FIG. 3b illustrates an exemplary set of displays for selecting a message composer state in accordance with the present invention. From display 350 a composer can select a particular state or have the state automatically selected. When the composer selects the Select State option from screen 350, the composer is provided with screen 360, which provides a number of state categories. Once the composer selects a particular state category, screen 370 allows the composer to select a particular state from within the selected state category.

Referring back to FIG. 3a, using composer state database 106, the composer state determiner 104 identifies the message composer state identification code corresponding to the determined state (step 306). The composer state determiner 104 accesses address database 114 to determine whether the message recipient's device is capable of decoding the composer state information (step 308). When the recipient's device is not capable of decoding message composer state information, i.e., it does not include a composer state decoder 204 (“No” path out of decision step 308), the message composer state information is attached to the message in a manner which can be interpreted by the message recipient (step 310). For example, if the message is an e-mail message, the state information can be attached to the e-mail message in the form of a text, audio, picture, video, or the like file. Alternatively, the message composer state identification code corresponding to the message composer's state can be included in the header or body of the message. The message is then transmitted to the message recipient (step 314). As another alternative, when the recipient's device cannot decode the message composer state, the message can be transmitted without including the message composer state information.

If the receiver is able to decode the message composer state information (“Yes” path out of decision step 308), then the composer state encoder 110 encodes the message composer state (i.e., the composer state identification code, privacy indicator and priority indicator) with the message (step 312). The message is then transmitted to the message recipient (step 314). Instead of transmitting the message after the message composer state is encoded, the composer can further manipulate the message, or store the message for manipulation or transmission at some future time.

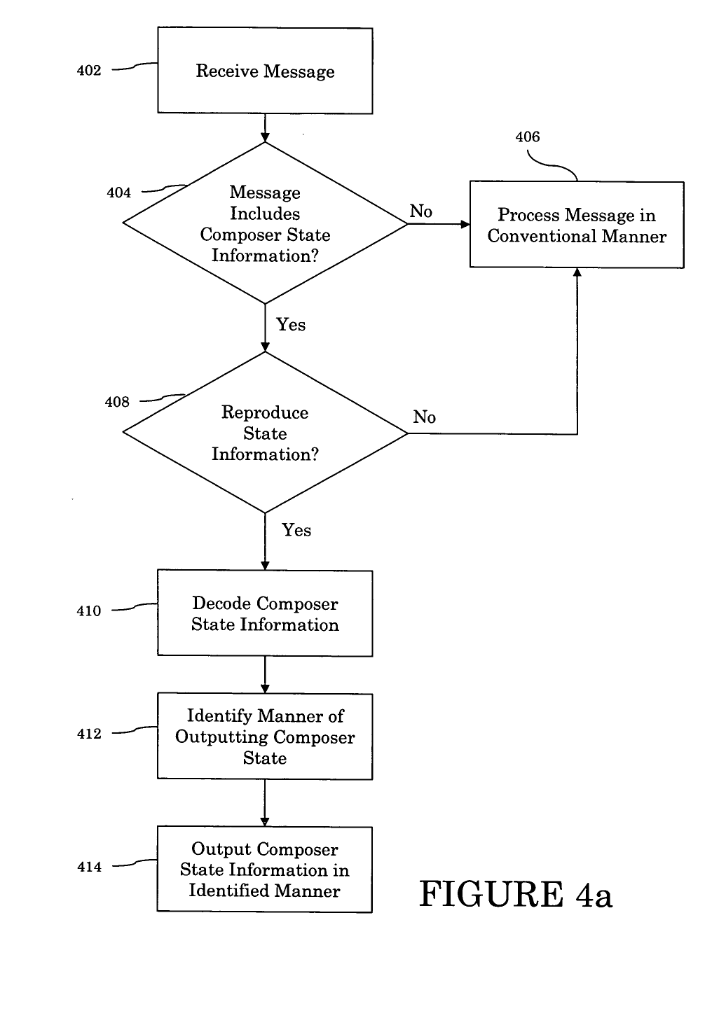

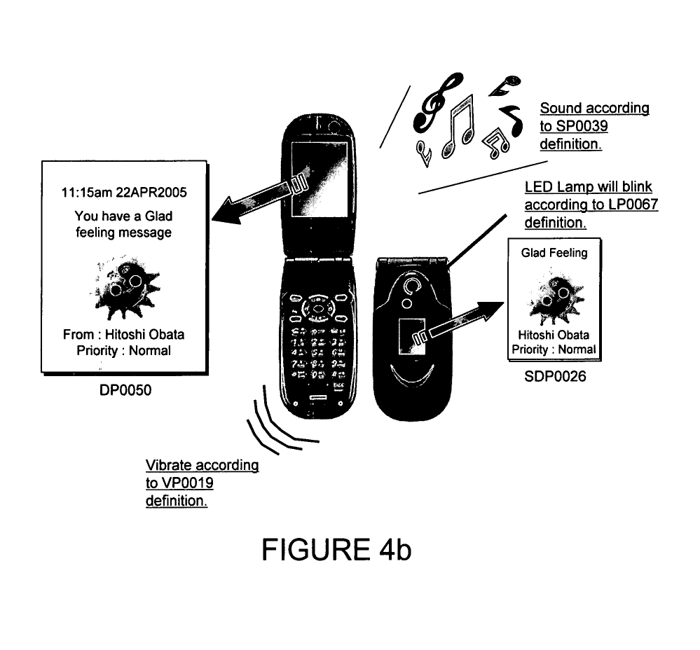

FIG. 4a illustrates a flow diagram of an exemplary method for receiving and decoding a message which conveys a composer's state. When a message is received by the recipient's device, the message analysis component 208 determines whether the message includes message composer state information (step 404). If the message does not include message composer state information (“No” path out of decision step 404), then the message is processed in a conventional manner (step 406), which can include storing the message in message database 220 for later retrieval.

If the message analysis component 208 determines that the message includes message composer state information (“Yes” path out of decision step 404), then the composer state filter 210 accesses address database 212 to determine, based on an information element associated with the message composer's address information, whether the message composer state information should be reproduced (step 408). If the composer state filter 210 determines that the message composer state information should not be reproduced (“No” path out of decision step 408), then the message is processed in accordance with conventional procedures (step 406).

When the composer state filter 210 determines that the message state should be reproduced (“Yes” path out of decision step 408), then the composer state decoder 204 decodes the composer's state (step 410). Using information stored in the composer state database 206, the composer state decoder 204 identifies the manner of outputting the message composer state (step 412) and outputs the message composer state in the identified manner using output device 202 (step 414).

The message composer state can be output immediately upon receipt of the message or after a delay. Specifically, the receiving device may not be readily accessible when the message is received. Accordingly, the message recipient may miss the state information if it is output immediately upon receipt of the message. To prevent the message recipient from missing the output of the message composer state, the present invention allows the message recipient to set a delay between reception of a message and reproduction of the message composer's state. The delay can be based upon a predetermined time period (e.g., 10 seconds after the normal ring-tone or vibration indicating that a message has been received). The output of the message composer state can also be based upon a predetermined action at the receiver, such as the actuation of a button or switch on the receiver. Moreover, the message composer state information can be output again based upon the actuation of a button or switch at the receiver.

FIG. 4b illustrates outputting of the glad state (state identification 0008). Accordingly, display pattern DP0050 is output on the LCD, sub-display pattern SDP0026 on the sub-LCD, a vibration pattern according to vibration pattern VP0019, a blinking of the LED lamp according to LP0067, and a sound according to sound pattern SP0039. The output illustrated in FIG. 4b is for a state which has been indicated as no privacy, and accordingly, the LCD and sub-LCD display the identification of the composer. As illustrated in FIG. 4b, the state was sent with a normal priority level.

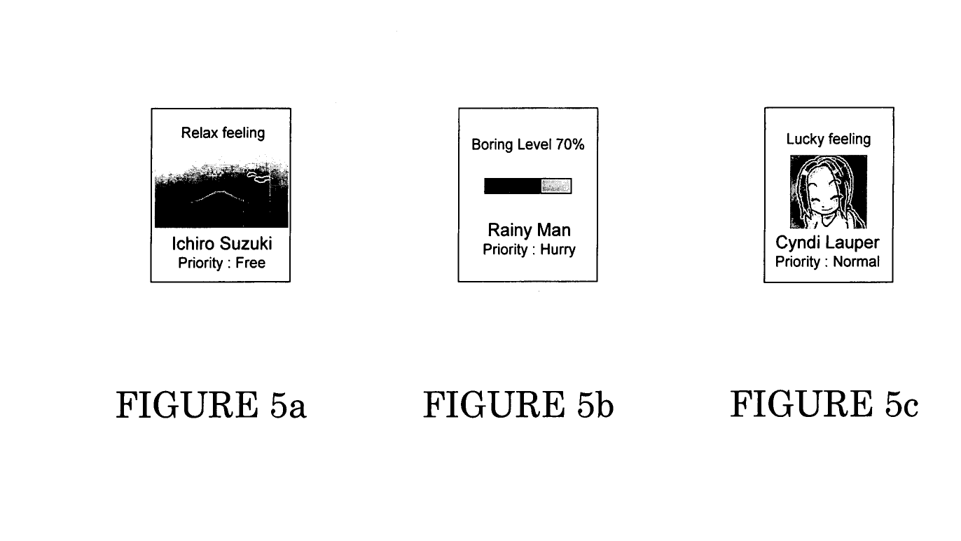

FIGS. 5a-5c illustrate exemplary message composer state outputs in accordance with the present invention. Specifically, the message composer state outputs are suitable for output on an LCD screen of a communication device.

In addition to, or as an alternative to, outputting the composer's state on the device receiving the message, the composer's state can be output to an external device. For example, any communication technology (e.g., Bluetooth, wireless or wired local area network (LAN), infrared, ultra-wideband, USB and/or the like technology) can convey the composer's state information to any type of external device (e.g., a computer, television, robot and/or the like).

In the description above, when the receiving device can decode composer state information, only the composer state identification code, priority indicator and privacy indicator are encoded with the message. However, additional information for outputting the composer's state can be encoded with, or attached to the message. For example, the message can include a picture or animation for output on a display device of the receiving device, or a sound file for output from a speaker of the receiving device.

Although exemplary embodiments have been described as conveying a single composer's state to a message recipient, more than one composer's state can be conveyed. In this case, the composer's states can be output in succession, the order being determined when the composer's state is encoded in the message.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A communication device, comprising:
a composer state determiner, which determines a message composer's state;
an encoder coupled to the composer state determiner, which encodes the message composer's state with a message; and
a transmitter coupled to the encoder, which transmits the message with the encoded message composer's state.

2. The communication device of claim 1, further comprising:
a composer state database coupled to the composer state determiner, which stores information associated with a plurality of different composer states.

3. The communication device of claim 2, wherein the information associated with each of the plurality of different composer states includes a state identification, state category, state name and state decoding actions.

4. The communication device of claim 1, wherein the composer state determiner determines the message composer's state by analyzing the message.

5. The communication device of claim 1, further comprising:
an input coupled to the composer state determiner, wherein the composer state determiner determines the message composer's state using an indication received from the input.

6. The communication device of claim 5, further comprising:
an input device coupled to the input, wherein the input device is a keypad, keyboard, mouse, jog-dial switch, joystick, bar code reader, microphone, blood pressure sensor, heart rate sensor, temperature sensor, image capture device or acceleration sensor.

7. The communication device of claim 1, further comprising:
a receiver which receives another message, wherein the another message is encoded with another message composer's state;
a decoder coupled to the receiver, which decodes the another message composer's state; and
an output coupled to the decoder, which outputs an indication of the another message composer's state.

8. The communication device of claim 7, further comprising:
a composer state filter coupled to the decoder, wherein the composer state filter accesses an address database to determine whether to decode the another message composer's state.

9. The communication device of claim 8, further comprising:
a message analysis component coupled to the composer state filter, wherein the message analysis component determines whether the another message includes an encoded message composer's state.

10. The communication device of claim 7, wherein the output is a speaker, vibrator, lamp, display, sub-display, backlight of the display, backlight of the sub-display or sounder device.

11. The communication device of claim 1, wherein the communication device is a wired telephone, wireless telephone, pager, personal digital assistant or personal computer.

12. The communication device of claim 1, wherein the transmitter transmits the message with the encoded message composer's state over a wireless voice network, wireless data network, wired voice network or wired data network.

13. The communication device of claim 1, further comprising:
an address database coupled to the composer state determiner, wherein the address database includes an address of a recipient of the message.

14. The communication device of claim 1, wherein the message is a voice, video, audio or text message.

15. The communication device of claim 1, wherein the encoded message composer's state comprises an encoded state identification code.

16. The communication device of claim 15, wherein the encoded message composer's state further comprises a privacy or priority indicator.

17. The communication device of claim 1, wherein the composer state determiner comprises:
a composer state analyzer, which analyzes a message to determine a message composer's state; and
a composer state detector, which determines a message composer state based on an indication received from an input.

18. The communication device of claim 1, wherein a plurality of message composer states corresponding to the determined message composer's state are encoded with the message.

19. A method for conveying a message composer's state, comprising the acts of:
determining a message composer's state;
encoding the message composer's state in a message; and
transmitting the encoded message to a message recipient.

20. The method of claim 19, further comprising the acts of:
receiving the encoded message;
decoding the message composer's state; and
outputting the message composer's state to the message recipient.

21. The method of claim 20, wherein the message composer's state is output on a speaker, vibrator, lamp, display, sub-display, backlight of the display, backlight of the sub-display or sounder device.

22. The method of claim 20, wherein the message composer's state is output after a delay from receipt of the message.

23. The method of claim 22, wherein the delay is a predetermined amount of time.

24. The method of claim 22, wherein the delay is based upon actuation of a button or switch of a receiving device.

25. The method of claim 20, wherein another device outputs the message composer's state.

26. The method of claim 19, wherein the act of determining the message composer's state is based at least in part on a content of the message.

27. The method of claim 19, wherein the act of determining the message composer's state is based at least in part on an indication provided by the message composer.

28. The method of claim 27, wherein the indication is received from a keypad, keyboard, mouse, jog-dial switch, joystick, bar code reader, microphone, blood pressure sensor, heart rate sensor, temperature sensor, image capture device or acceleration sensor.

29. The method of claim 19, wherein the encoded message composer's state comprises an encoded state identification code.

30. The method of claim 29, wherein the encoded message composer's state further comprises a privacy or priority indicator.

31. The method of claim 20, further comprising the act of:
accessing an address database to determine whether to decode the message composer's state.

32. The method of claim 20, further comprising the act of:
determining whether the received message includes an encoded message composer's state.

33. A system comprising:
a transmitting device, which includes
a composer state determiner, which determines a message composer's state;
an encoder coupled to the composer state determiner, which encodes the message composer's state in a message; and
a transmitter which transmits the encoded message;
a receiving device, coupled to the transmitting device via a communication medium, which includes
a receiver which receives the encoded message;
a decoder coupled to the receiver, which decodes the encoded message; and
an output coupled to the decoder, which outputs an indication of the message composer's state.

34. The system of claim 33, wherein the transmitting device further comprises:
a composer state database coupled to the composer state determiner, which stores information associated with a plurality of different composer states.

35. The system of claim 34, wherein the information associated with each of the plurality of different composer states includes a state identification, state category, state name and state decoding actions.

36. The system of claim 35, wherein the state decoding actions identify actions to be performed by the output of the receiving device.

37. The system of claim 36, wherein the output of the receiving device is a speaker, vibrator, lamp, display, sub-display, backlight of the display, backlight of the sub-display or sounder device.

38. The system of claim 33, wherein the composer state determiner determines the state associated with the composer by analyzing the message.

39. The system of claim 33, wherein the transmitting device further comprises:
an input coupled to the composer state determiner, wherein the composer state determiner determines the state associated with the composer using an indication received from the input.

40. The system of claim 39, wherein the transmitting device further comprises:
an input device coupled to the input, wherein the input device is a keypad, keyboard, mouse, jog-dial switch, joystick, bar code reader, microphone, blood pressure sensor, heart rate sensor, temperature sensor, image capture device or acceleration sensor.

41. The system of claim 33, wherein the receiving device further comprises:
a composer state filter coupled to the decoder, wherein the composer state filter accesses an address database to determine whether to decode the message composer's state.

42. The system of claim 41, wherein the receiving device further comprises:
a message analysis component coupled to the composer state filter, wherein the message analysis component determines whether the message includes an encoded message composer's state.

43. The system of claim 33, wherein the transmitting device further comprises:
an address database coupled to the composer state determiner, wherein the address database includes an address of an intended recipient of the message.

44. The system of claim 33, wherein the receiving device further comprises:
a composer state database coupled to the decoder, which stores information associated with a plurality of different composer states.

45. The system of claim 33, wherein the encoded composer's state comprises an encoded state identification code.

46. The system of claim 45, wherein the encoded composer's state further comprises a privacy or priority indicator.

47. A method for conveying a message composer's state, comprising the acts of:
encoding, by a transmitting device, a message composer's state in a message;
decoding, by a receiving device, the message composer's state; and
outputting, by the receiving device, an indication of the message composer's state to a message recipient.

48. The method of claim 47, wherein the message composer's state is output on a speaker, vibrator, lamp, display, sub-display, backlight of the display, backlight of the sub-display or sounder device.

49. The method of claim 47, wherein the message composer's state is output after a delay from receipt of the message.

50. The method of claim 49, wherein the delay is a predetermined amount of time.

51. The method of claim 49, wherein the delay is based upon actuation of a button or switch of a receiving device.

52. The method of claim 47, wherein the message composer's state is based on a content of the message.

53. The method of claim 47, wherein the message composer's state is based on an indication provided by the message composer.

54. The method of claim 53, wherein the indication is received from a keypad, keyboard, mouse, jog-dial switch, joystick, bar code reader, microphone, blood pressure sensor, heart rate sensor, temperature sensor, image capture device or acceleration sensor.

55. The method of claim 47, wherein the encoded message composer's state comprises an encoded state identification code.

56. The method of claim 55, wherein the encoded message composer's state further comprises a privacy or priority indicator.

57. A method for conveying a message composer's state, comprising the acts of:
receiving a message with an encoded message composer's state;
decoding the message composer's state; and
providing the message composer's state to an output device.

58. The method of claim 57, wherein a message composer's device performs the acts of:
determining the message composer's state;
encoding the message composer's state in the message; and
providing the encoded message to a transmitter.

59. The method of claim 57, wherein the output device is a speaker, vibrator, lamp, display, sub-display, backlight of the display, backlight of the sub-display or sounder device.

60. The method of claim 57, wherein the message composer's state is output after a delay from receipt of the message.

61. The method of claim 60, wherein the delay is a predetermined amount of time.

62. The method of claim 57, wherein the delay is based upon actuation of a button or switch of a receiving device.

63. The method of claim 57, wherein another device outputs the message composer's state.

64. The method of claim 58, wherein the act of determining the message composer's state is based at least in part on a content of the message.

65. The method of claim 58, wherein the act of determining the message composer's state is based at least in part on an indication provided by the message composer.

66. The method of claim 65, wherein the indication is received from a keypad, keyboard, mouse, jog-dial switch, joystick, bar code reader, microphone, blood pressure sensor, heart rate sensor, temperature sensor, image capture device or acceleration sensor.

67. The method of claim 57, wherein the encoded message composer's state comprises an encoded state identification code.

68. The method of claim 67, wherein the encoded message composer's state further comprises a privacy or priority indicator.

69. The method of claim 57, further comprising the act of:
accessing an address database to determine whether to decode the message composer's state.

70. The method of claim 57, further comprising the act of:
determining whether the received message includes an encoded message composer's state.
